(19) United States
(12) Patent Application Publication
(10) Pub. No.: US 2017/0279897 A1
(43) Pub. Date: Sep. 28, 2017

(54) Real-time Sensors in Complex Computing Networks

(71) Applicant: Jeffrey W. Mankoff, Dallas, TX (US)

(72) Inventor: Jeffrey W. Mankoff, Dallas, TX (US)

(21) Appl. No.: 15/076,876

(22) Filed: Mar. 22, 2016

(51) Int. Cl. H04L 29/08; G06F 17/30

(52) U.S. Cl. CPC H04L 67/141; H04L 67/1042; G06F 17/30864; G06F 17/30876

(57) ABSTRACT

This disclosure is directed to an apparatus for real-time routing of an input signal received from a real-time sensor to perform disparate computing operations in a complex computing network, wherein hut for the real-time routing of the input signal, which is necessarily rooted in computing technology, separate input signals would be needed for performing the disparate computing operations.

### TECHNICAL FIELD

This disclosure is directed to real-time sensors in complex computing networks and may be appropriately classified in USPC 709/246 or 709/238.

### BACKGROUND

There is a need for using a single input signal to perform disparate computing operations in a complex computing network without needing to use different input signals for performing the disparate computing operations.

### BRIEF SUMMARY

In some embodiments, an apparatus is provided for real-time routing of an input signal received from a real-time sensor to perform disparate computing operations in a complex computing network, wherein but for the real-time routing of the input signal, which are necessarily rooted in computing technology, separate input signals would be needed for performing the disparate computing operations. The apparatus comprises a signal communication interface for: establishing a first connection to an input signal system, wherein the input signal system comprises a real-time sensor for sensing an input signal and transmitting the input signal on a first connection and a second connection, wherein the input signal comprises an identification signal (or is associated with the identification signal or is associated with a separately transmitted identification signal), wherein the input signal transmitted on the first connection is used for executing a first computing operation, and wherein the input signal transmitted on the second connection is used for executing a second computing operation; receiving the input signal and/or the identification signal on the first connection; establishing a third connection to an identification database; and accessing, on the third connection, records in the identification database.

In some embodiments, the apparatus further comprises a gateway processor for executing the first computing operation, the first computing operation comprising: comparing the identification signal associated with the input signal to a record in the identification database; determining whether the identification signal matches a record in the identification database; in response to determining the identification signal does not match a record in the identification database, transmitting to the input signal system, a request for creating a record for the identification signal in the identification database; and in response to transmitting the request for creating a record for the identification signal in the identification database, receiving a second signal from the input signal system or the real-time sensor, the second signal comprising a response to the request for creating a record for the identification signal in the identification database, wherein the input signal transmitted on the second connection is received by an operations processor that executes the second computing operation.

In some embodiments, the transmission, to the input signal system or the real-time sensor, of the request for creating a record for the identification signal in the identification database is further based on a location of the real-time sensor.

In some embodiments, the transmission, to the input signal system or the real-time sensor, of the request for creating a record for the identification signal in the identification database is further based on an attribute of the second computing operation.

In some embodiments, the signal communication interface is further used for establishing a fourth connection to a programming processor, wherein the programming processor transmits a trigger signal that causes sensing of the input signal at the real-time sensor.

In some embodiments, the apparatus further comprises an application programming interface for communicating with the programming processor.

In some embodiments, the input signal is received from a computing device.

In some embodiments, the input signal is received from a mobile computing device.

In some embodiments, the input signal is received from a mobile non-computing device.

### BRIEF DESCRIPTION OF THE DRAWINGS

FIG. 1 is a block diagram of a complex computing network for real-time routing of an input signal received from a real-time sensor to perform disparate computing operations in the complex computing network, in accordance with some embodiments of the invention; and

FIG. 2 is a block diagram of a method for real-time routing of an input signal received from a real-time sensor to perform disparate computing operations in a complex computing network, in accordance with some embodiments of the invention.

All of these drawings are illustrations of certain embodiments. The scope of the claims is not limited to the specific embodiments illustrated in the drawings and described below.

### DETAILED DESCRIPTION OF THE EMBODIMENTS

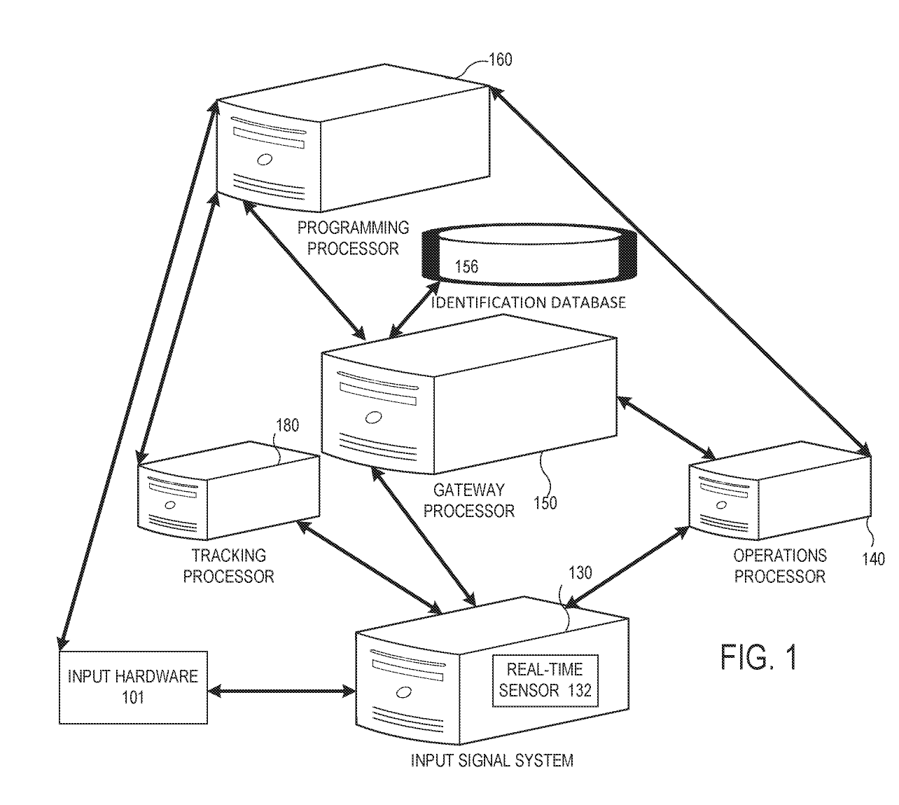

FIG. 1 is a block diagram of a complex computing network for real-time routing of an input signal received from a real-time sensor to perform disparate computing operations in the complex computing network. FIG. 1 may comprise an input hardware 101, an input signal system 130, an operations processor 140, a gateway processor 150, a programming processor 160, and a tracking processor 180. In some embodiments, the various processors described herein may be replaced with other types of processors. In some embodiments, the functionality of multiple devices in FIG. 1 may be combined in a single apparatus. The various processors described in this disclosure may refer to apparatuses, systems, devices, etc., comprising such processors. Such apparatuses may also comprise memory that stores computer-readable code, which when executed by the processor, causes the processor and/or other elements in the apparatus to perform the various methods described in this disclosure. In some embodiments, the term “signal” may refer to “data” or “information.”

The input hardware 101 may produce an input signal. The input hardware 101 may be a computing device such as a mobile computing device. Alternatively, the input hardware 101 may be non-computing hardware (e.g., a physical card). An input signal system 130 may comprise a real-time sensor 132. In some embodiments, the real-time sensor 132 may be a point-of-sale terminal such as a computing device (e.g., a mobile computing device, a non-mobile computing device). In some embodiments, the real-time sensor 132 may refer to any real-time means or computing means. The input hardware 101 may transmit an input signal and the real-time sensor 132 may sense (e.g., determine, receive, etc.) the input signal. Any sensor described in this disclosure may be a computing device. In some embodiments, a sensor in this disclosure may be a signal sensor. The input signal may be transmitted to at least one of the gateway processor 150 (e.g., on a first connection), the operations processor 140 (e.g., on a second connection), or the tracking processor 180 (e.g., on a fourth connection). In some embodiments, the connection between the gateway processor 150 and the identification database 156 (e.g., associated with a loyalty program) may be referred as a third connection.

In some embodiments, a portion of the input signal (e.g., the identification signal) is extracted by the input signal system 130 or the real-time sensor 132 and is transmitted to at least one of the gateway processor 150, the operations processor 140, or the tracking processor 180. In some embodiments, either different portions and/or the same portion of the input signal are transmitted to at least one of the gateway processor 150, the operations processor 140, or the tracking processor 180. In some embodiments, the input signal may be transformed by the input signal system 130 into one or more transformed signals, and each of the different transformed signals may be transmitted to at least one of the gateway processor 150, the operations processor 140, or the tracking processor 180. In some embodiments, each of the first connection, the second connection, the third connection, and the fourth connection may be distinct such that the only the gateway processor 150, and not the operations processor 140, may communicate with the input signal system 130 on the first connection, only the operations processor 140, and not the gateway processor 150, may communicate with the input signal system 130 on the second connection, etc. In alternate embodiments, at least one of the first connection, the second connection, the third connection, and the fourth connection may be coupled into a single connection.

In some embodiments, the gateway processor 150 may include a signal communication interface for establishing a first connection to the input signal system 130, and receiving the input signal on the first connection. In some embodiments, the gateway processor 150 may comprise or may be associated with an identification sensor for identifying the identification signal in the input signal. The signal communication interface may also be used for establishing a third connection to an identification database 156, and accessing records in the identification database 156 on the third connection. In some embodiments, the identification database 156 may be part of the gateway processor 150, while in other embodiments, the identification database 156 may be located remotely from the gateway processor 150. The gateway processor 150 may execute a first computing operation. The first computing operation may comprise comparing the identification signal in the input signal to a record in the identification database 156, and determining whether the identification signal matches a record in the identification database 156. In response to determining the identification signal does not match a record in the identification database 156, the gateway processor 150 may transmit to the input signal system 130 a request for creating a record for the identification signal in the identification database 156. In response to transmitting the request for creating a record for the identification signal in the identification database 156, the gateway processor 150 may receive a second signal from the input signal system 130. The second signal may comprise a response to the request for creating a record for the identification signal in the identification database 156. In some embodiments, the response may comprise acceptance of the request for creating a record for the identification signal in the identification database 156. Alternatively, the response may comprise declining the request for creating a record for the identification signal in the identification database 156.

The input signal transmitted on the second connection from the input signal system 130 to the operations processor 140 may be used by the operations processor 140 to execute a second computing operation. The second computing operation executed by the operations processor 140 may be different from the first computing operation executed by the gateway processor 150. The second computing operation may be executed at least one of before, after, or substantially simultaneously with the first computing operation. While the disclosure indicates that the first computing operation and the second computing operation are executed by different processors, in other embodiments, the first computing operation and the second computing operation may executed by the same processor.

In some embodiments, in response to determining the identification signal does not match a record in the identification database 156, the gateway processor 150 may transmit to the input signal system 130 or to the operations processor 140 (either directly or via the input signal system 130) an indication that a record does not exist in the identification database 156. In such embodiments, before the gateway processor 150 transmits, to the input signal system 130, a request for creating a record for the identification signal in the identification database 156, or before a request for creating a record for the identification signal in the identification database 156 is presented at the real-time sensor 132, the operations processor 140 may execute the second computing operation. The operations processor 140 may then communicate the completion of the second computing operation to the input signal system 130 and/or the gateway processor 150. The input signal system 130, either on its own or based on a message received from the gateway processor 150, may prompt the real-time sensor 132 to sense a second input signal, which may be a request for creating a record for the identification signal in the identification database 156. The second input signal may be the same as or different from the input signal. The second input signal (or an identification signal comprised in the second input signal) may be transmitted from the input signal system 130 to the gateway processor 150. The gateway processor 150 may access the identification database 156 to create a record in the identification database 156 for the identification signal comprised in the second input signal. Therefore, in such embodiments, the identification signal in the first input signal may be used to determine whether a record for the identification signal exists in the identification database 156, and the identification signal in the second input signal may be used to create a record for the identification signal in the identification database 156. The identification signal in the first input signal may either be the same as or different from the identification signal in the second input signal. However, both identification signals may be associated with the same input hardware.

In some embodiments, in response to determining the identification signal matches a record in the identification database 156, the gateway processor 150 may transmit to the input signal system 130 or to the operations processor 140 (either directly or via the input signal system 130) an indication that a record exists in the identification database 156. Additionally, the gateway processor 150 may transmit a transformational attribute (e.g., a discount) that is applied to the input signal. Alternatively, the transformational attribute may be generated by the input signal system 130 and/or the operations processor 140 upon receiving the indication (e.g., from the gateway processor 150) that a record exists in the identification database 156. The transformational attribute may be applied to the input signal at at least one of the input signal system 130 and/or the operations processor 140 and/or the gateway processor 150. As an example, the transformational attribute may be applied to the input signal at least one of prior to, during, or after the second computing operation. In some embodiments, either prior to, during, or after execution of the second computing operation, the operations processor 140 may transmit a message to the input signal system 130. The message may be displayed on a display associated with the real-time sensor 132. The message may be associated with the transformed input signal, i.e., the result of applying the transformational attribute to the input signal.

In some embodiments, the functionality of the gateway processor 150 may be performed by two separate processors that may interact with each other. One of the processors (e.g., a communications processor) may perform the functions of interacting with the input signal system 130 such as receiving the input signal, the second input signal, or the identification signal, and transmitting a second signal to the input signal system 130, and/or transmitting a prompt or prompting the real-time sensor 132 in the input signal system 130 for sensing a second input signal. The other processor (e.g., a matching processor) may perform the functions of interacting with the identification database 156 and determining whether a matching record for the identification signal exists in the identification database 156.

In some embodiments, the transmission, to the input signal system 130, of the request for creating a record of the identification signal in the identification database 156 is further based on a location of the real-time sensor 130. In some embodiments, the transmission, to the input signal system 130, of the request for creating a record for the identification signal in the identification database 156 is further based on an attribute of the second computing operation. In some embodiments, the signal communication interface is further used for establishing a connection to a programming processor 160, wherein the programming processor transmits a trigger signal that causes sensing of the input signal at the real-time sensor 132.

In some embodiments, the gateway processor 150 further comprises a first application programming interface (API) for communicating with the programming processor 160, and a second API, different from the first API, for communicating with the input signal system 140. These APIs may be specialized non-generic APIs that are developed for the particular purpose of communicating with particular devices.

In some embodiments, the input signal or the identification signal may be associated with a computing token or tokenized. Tokenization may be a form of data transformation. Therefore, the input signal and/or identification signal may be converted to a token or token signal. The input signal and/or identification signal may not be able to be recovered or retransformed from the token signal. In some embodiments, the token signal, instead of or in addition to the input signal and/or the identification signal, may be used for performing the first computing operation described in this disclosure. In some embodiments, the token signal may be shared with other processors, or networks such as computing networks or social networks. The tokenization may be executed by at least one of the input signal system 130 (and/or the real-time sensor 132), the gateway processor 150, or the operations processor 140. In some embodiments, the gateway processor 150 may execute a computing operation for storing a token (e.g., the token associated with the identification signal) in the record for the identification signal in the identification database 156.

In some embodiments, a method is provided for performing the various steps performed by any apparatus described herein. In some embodiments, a non-transitory computer-readable medium comprising code is provided for causing a computing device to perform the various methods described herein.

In some embodiments, the various devices of FIG. 1 correspond to and are the equivalent of devices with the same reference numerals (or different reference numerals) of FIG. 1 in the applications incorporated-by-reference below, even though some of the devices of FIG. 1 in the instant application carry different names from the devices of FIG. 1 in the applications incorporated-by-reference below. Although not shown, in some embodiments, the various devices of FIG. 1 include the same elements that are comprised in the devices associated with the same reference numerals (or different reference numerals) of FIG. 1 in the applications incorporated-by-reference below. In some embodiments, the various devices of FIG. 1 perform the same or similar operations as the devices associated with the same reference numerals (or different reference numerals) of FIG. 1 in the applications incorporated-by-reference below.

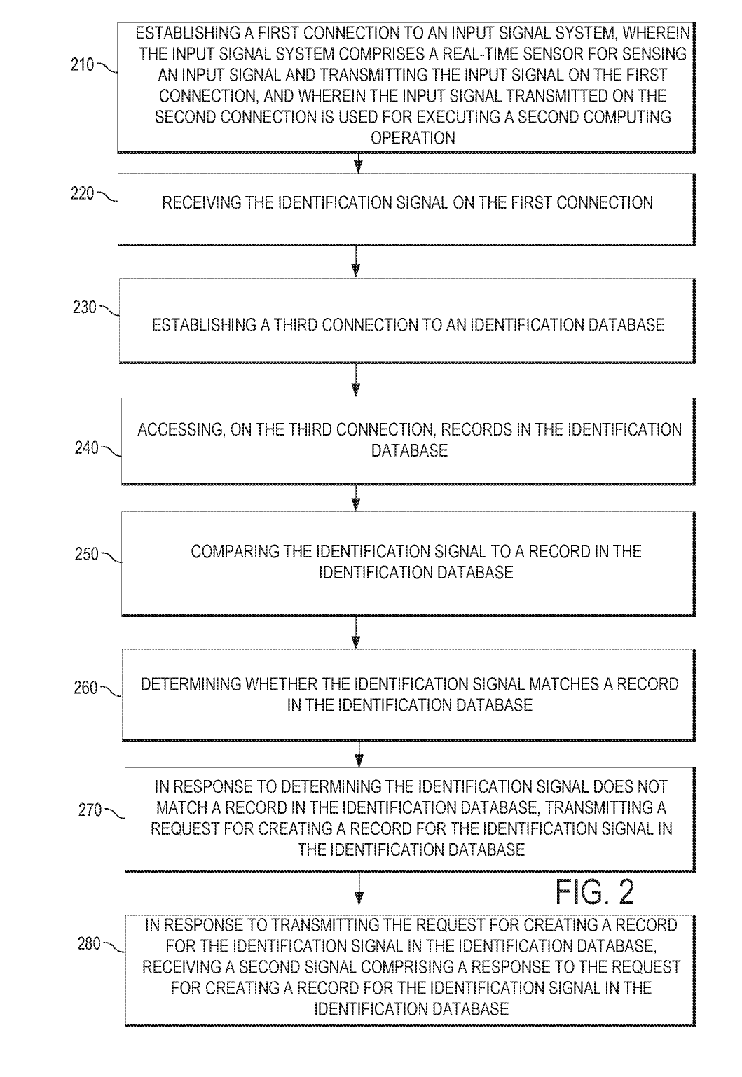

FIG. 2 is a block diagram of a method for real-time routing of an input signal received from a real-time sensor to perform disparate computing operations in a complex computing network, wherein but for the real-time routing of the input signal, which is necessarily rooted in computing technology, separate input signals would be needed for performing the disparate computing operations. The various blocks of FIG. 2 may be executed in a different order from that shown in FIG. 2. At block 210, the method comprises establishing a first connection to an input signal system, wherein the input signal system comprises a real-time sensor for sensing (e.g., determining, receiving, etc.) an input signal and transmitting the input signal on a first connection and a second connection, wherein the input signal comprises an identification signal, wherein the input signal transmitted on the first connection is used for executing a first computing operation, and wherein the input signal transmitted on the second connection is used for executing a second computing operation. At block 220, the method comprises receiving the input signal and/or the identification signal on the first connection. At block 230, the method comprises establishing a third connection to an identification database. At block 240, the method comprises accessing, on the third connection, records in the identification database.

At block 250, the method comprises comparing the identification signal to a record in the identification database. At block 260, the method comprises determining whether the identification signal matches a record in the identification database. At block 270, the method comprises in response to determining the identification signal does not match a record in the identification database, transmitting to the input signal system or the real-time sensor, a request for creating a record for the identification signal in the identification database. At block 280, the method comprises in response to transmitting the request for creating a record for the identification signal in the identification database, receiving a second signal from the input signal system or the real-time sensor, the second signal comprising a response to the request for creating a record for the identification signal in the identification database. In some embodiments, the response comprises acceptance of the request for creating a record for the identification signal in the identification database. In some embodiments, any signal as described herein may be a non-transitory signal. In other embodiments, any signal as described herein may be a transitory signal.

In some embodiments, the input signal is associated with a computing token. In some embodiments, the identification signal is associated with a computing token. In some embodiments, the input signal or the identification signal is tokenized. In some embodiments, the input signal or the identification signal is tokenized by the input signal system or by the input hardware such as a mobile device. In some embodiments, the input signal or the identification signal is tokenized by the gateway processor. In some embodiments, the input signal or the identification signal is tokenized by the operations processor. In some embodiments, the identification database is located remotely from the gateway processor, while in other embodiments, the identification database is coupled to the gateway processor. In some embodiments, the gateway processor is further configured for storing a computing token in the record for the identification signal in the identification database.

The present application incorporates-by-reference (IBR) the entirety of U.S. application Ser. No. 14/794,593, filed Jul. 8, 2015, titled “Systems and Methods for Enrolling Consumers in a Program,” for all purposes.

The present application incorporates-by-reference the entirety of U.S. application Ser. No. 13/937,132, filed Jul. 8, 2013, titled “Systems and Methods for Registering Consumers in a Consumer Program While Accessing a Network,” for all purposes.

The present application incorporates-by-reference the entirety of U.S. application Ser. No. 13/708,814, filed Dec. 7, 2012, titled “Systems and Methods for Registering Consumers in a Consumer Program While Accessing a Network,” for all purposes.

The present application incorporates-by-reference the entirety of U.S. Provisional Application No. 61/568,637, filed Dec. 8, 2011, titled “Systems and Methods for Using a Payment System to Register Consumers in a Loyalty Program,” for all purposes.

In some embodiments, the input signal transmitted from the input hardware may comprise a second identification signal. In some embodiments, the input hardware may comprise this second identification signal. In some embodiments, the second identification signal may be a token or a number that is generated based on any components of the input signal. In some embodiments, the second identification signal may be dynamically generated at the time of transmitting the input signal to the input signal system, comprising the real-time sensor. In some embodiments, the second identification signal may be transmitted to the input signal system separately from the input signal and/or the identification signal. In some embodiments, the token described in this disclosure may be a type of second identification signal. As an example, the input signal may comprise an identification signal. Either the input signal or the identification signal may include a name, an input hardware number, an address, a phone number, or another number or alphanumeric quantity other than the numbers listed herein, etc. In some embodiments, the second identification signal and the identification signal may refer to the same signal, while in other embodiments, the second identification signal and the identification signal may refer to different signals.

In some embodiments, the second identification signal may not be secured or encrypted, unlike the input signal and/or the identification signal. In other embodiments, the second identification signal may be secured or encrypted as well; however the level of security or encryption of the second identification signal may be less than or equal to the level of security or encryption of the input signal or the identification signal. In some embodiments, any of the features or processes described in any part of this disclosure, including any applications incorporated herein by reference, that are associated with the input signal and/or the identification signal, may additionally or alternatively be associated with the second identification signal. Therefore, the second identification signal may be transmitted to the gateway processor, and the gateway processor may use the second identification signal to determine whether a matching record exists in the identification database. Additionally, the second identification signal may be used to create a new record in the identification database if a matching record does not exist in the database.

In some embodiments, the input hardware may comprise a mobile device such as a mobile phone, watch, fitness band, etc. In such embodiments, the identification signal and/or the second identification signal may comprise a signal that is unique to the mobile device or to an account associated with the mobile device. For example, such a signal may be a mobile device phone number, or any other device identification numbers. In some embodiments, the mobile device may comprise or have access to (e.g., from a cloud server) digital versions of multiple input hardware. In some embodiments, the mobile device may include functionality of both the input hardware and the input signal system. Therefore, the mobile device may perform any process or comprise any feature that is described with respect to the input hardware and/or the input signal system. For example, any message that may be presented on the display associated with the real-time sensor or the input signal system, may additionally or alternatively be presented on a display of the mobile device. In some embodiments, any of the systems illustrated in FIG. 1 (e.g., the input signal system) may determine that the input hardware is a mobile device. In response to determining that the input hardware is a mobile device, the system may prompt the mobile device for transmission of an input signal. The input signal transmitted from the mobile device may include at least one of the identification signal and/or the second identification signal.

In alternate embodiments, the input signal transmitted from the mobile device may not include the identification signal and/or the second identification signal, or may include just the identification signal and not the second identification signal. The input signal may include information necessary to perform the second computing operation. Following the second computing operation, any of the systems of FIG. 1 may prompt the mobile device for transmission of the identification signal and/or the second identification signal. In some embodiments, any transmissions between the mobile device and any of the systems may be via any short range (e.g., near field communication, Bluetooth, Bluetooth Low Energy, etc.) or long range wireless transmission mechanisms (e.g., cellular, Wi-Fi, etc.). In some embodiments, the frequency of transmission may not be limited to any particular frequency of the electromagnetic spectrum.

In some embodiments, prior to transmission of the identification signal and/or the second identification signal to the system, the system may prompt the user of the mobile device for permission to transmit the identification signal and/or the second identification signal. For a subsequent transmission of the identification signal and/or the second identification signal at the same establishment (e.g., a single establishment may be associated with multiple geographical locations), permission of the user is not required to transmit the identification signal and/or the second identification signal to any of the described systems.

The system may determine, based on the identification signal and/or the second identification signal, that a matching record associated with the identification signal and/or the second identification signal is not present in the identification database. In such embodiments, the system may send to the mobile device a request to the mobile device to create a record in the identification database. The mobile device may respond either positively or negatively in response to the request.

In some embodiments, the input hardware (e.g., the mobile device) may be associated with multiple identification signals and/or multiple second identification signals. In such embodiments, at least one of the identification signals or second identifications signals such as a mobile device number may be used to link together the multiple identification signals and/or the multiple second identification signals. This linking second identification signal may be the identifications signal that is used by the gateway processor to determine whether a matching record exists for the linking second identification signal in the identification database.

In some embodiments, an apparatus is provided for real-time routing of an input signal and an identification signal received from a mobile device via a real-time computing means to perform disparate computing operations in a complex computing network, wherein but for the real-time routing of the input signal and the identification signal, which is necessarily rooted in computing technology, the identification signal would need to be included in the input signal. The apparatus comprises a signal communication interface for: establishing a first connection to an input signal system, wherein the input signal system comprises a real-time computing means for sensing the input signal and transmitting the input signal on a first connection and for sensing the identification signal and transmitting the identification signal on a second connection, wherein the input signal transmitted on the first connection is used for executing a first computing operation, and wherein the identification signal transmitted on the second connection is used for executing a second computing operation; receiving the identification signal on the first connection; establishing a third connection to an identification database; and accessing, on the third connection, records in the identification database; and a gateway processor for executing the first computing operation, the first computing operation comprising: comparing the identification signal to a record in the identification database; determining whether the identification signal matches a record in the identification database; in response to determining the identification signal does not match a record in the identification database, transmitting to the input signal system or to a mobile device, a request for creating a record for the identification signal in the identification database; and in response to transmitting the request for creating a record for the identification signal in the identification database, receiving a second signal from the real-time sensor, the input signal system, or the mobile device, the second signal comprising a response to the request for creating a record for the identification signal in the identification database, wherein the input signal transmitted on the second connection is received by an operations processor that executes the second computing operation.

In some embodiments, an apparatus for real-time routing of an input signal and an identification signal received from an input data system to perform disparate computing operations in a complex computing network, wherein but for the real-time routing of the input signal and the identification signal, which is necessarily rooted in computing technology, the identification signal would need to be included in the input signal. The apparatus comprises a signal communication interface for: establishing a first connection to an input signal system, wherein the input signal system transmits the input signal on a first connection and transmits the identification signal on a second connection, wherein the input signal transmitted on the first connection is used for executing a first computing operation, and wherein the identification signal transmitted on the second connection is used for executing a second computing operation; receiving the identification signal on the first connection; establishing a third connection to an identification database; and accessing, on the third connection, records in the identification database; and a gateway processor for executing the first computing operation, the first computing operation comprising: comparing the identification signal to a record in the identification database; determining whether the identification signal matches a record in the identification database; in response to determining the identification signal does not match a record in the identification database, transmitting to the input signal system, a request for creating a record for the identification signal in the identification database; and in response to transmitting the request for creating a record for the identification signal in the identification database, receiving a second signal from the real-time sensor or the input signal system, the second signal comprising a response to the request for creating a record for the identification signal in the identification database, wherein the input signal transmitted on the second connection is received by an operations processor that executes the second computing operation. In some embodiments, the input signal system comprise at least one of a mobile device or a real-time sensor, which may be also referred to as any real-time computing means in some embodiments.

In some embodiments, the input signal may comprise payment information. In some embodiments, the input hardware may comprise a card such as a payment card, an identification card, a loyalty card, etc., or a device such as a payment device, or mobile device such as a mobile phone or watch. In some embodiments, the first computing operation may comprise a loyalty processing operation, and the second computing operation may comprise a payment or a transaction processing operation. In some embodiments, the identification database may be associated with a loyalty program. In some embodiments, the second identification signal may be referred to as a loyalty token or loyalty identification number. In some embodiments, the identification signal may comprise identification information associated with the input signal or associated with a user of the input signal system. In some embodiments, the sensor may comprise or be associated with a display that displays an amount. In some embodiments, the amount may be displayed on the display upon receiving information associated with a product or service to be purchased. In some embodiments, the transformational attribute as described previously may be applied to the amount, and the discounted amount may be displayed on the display.

The present disclosure provides several important technical advantages that will be readily apparent to one skilled in the art from the figures, descriptions, and claims. Moreover, while specific advantages have been enumerated above, various embodiments may include all, some, or none of the enumerated advantages.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

1. An apparatus for real-time routing of an input signal received from a real-time sensor to perform disparate computing operations in a complex computing network, wherein but for the real-time routing of the input signal, which is necessarily rooted in computing technology, separate input signals would be needed for performing the disparate computing operations, the apparatus comprising:
a signal communication interface for:
establishing a first connection to an input signal system, wherein the input signal system comprises a real-time sensor for sensing an input signal and transmitting the input signal on a first connection and a second connection, wherein the input signal is associated with an identification signal, wherein the input signal transmitted on the first connection is used for executing a first computing operation, and wherein the input signal transmitted on the second connection is used for executing a second computing operation;
receiving the identification signal on the first connection,
establishing a third connection to an identification database; and
accessing, on the third connection, records in the identification database; and
a gateway processor for executing the first computing operation, the first computing operation comprising:
comparing the identification signal associated with the input signal to a record in the identification database;
determining whether the identification signal matches a record in the identification database;
in response to determining the identification signal does not match a record in the identification database, transmitting to the input signal system, a request for creating a record for the identification signal in the identification database; and
in response to transmitting the request for creating a record for the identification signal in the identification database, receiving a second signal from the real-time sensor or the input signal system, the second signal comprising a response to the request for creating a record for the identification signal in the identification database,
wherein the input signal transmitted on the second connection is received by an operations processor that executes the second computing operation.

2. The apparatus of claim 1, wherein the transmission, to the input signal system or the real-time sensor, of the request for creating a record for the identification signal in the identification database is further based on a location of the real-time sensor.

3. The apparatus of claim 1, wherein the transmission, to the input signal system or the real-time sensor, of the request for creating a record for the identification signal in the identification database is further based on an attribute of the second computing operation..

4. The apparatus of claim 1, wherein the signal communication interface is further for establishing a fourth connection to a programming processor, wherein the programming processor transmits a trigger signal that causes sensing of the input signal at the real-time sensor.

5. The apparatus of claim 4, further comprising an application programming interface for communicating with the programming processor.

6. The apparatus of claim 1, wherein the input signal is received from at least one of a computing device, a mobile computing device, or a non-mobile computing device.

7. The apparatus of claim 1, wherein the identification signal is comprised in the input signal.

8. The apparatus of claim 1, wherein the identification signal is received at the input signal system separately from the input signal.

9. The apparatus of claim 1, wherein the input signal is associated with a computing token.

10. The apparatus of claim 1, wherein the identification signal is associated with a computing token.

11. The apparatus of claim 1, wherein the input signal or the identification signal is tokenized.

12. The apparatus of claim 11, wherein the input signal or the identification signal is tokenized by the input signal system.

13. The apparatus of claim 11, wherein the input signal or the identification signal is tokenized by the gateway processor.

14. The apparatus of claim 1, wherein the identification database is located remotely from the gateway processor.

15. The apparatus of claim 1, wherein the response comprises acceptance of the request for creating a record for the identification signal in the identification database.

16. The apparatus of claim 15, wherein the gateway processor is further for storing a computing token in the record for the identification signal in the identification database.

17. The apparatus of claim 1, wherein the second computing operation is executed before execution of the receiving step of the first computing operation.

18. The apparatus of claim 1, wherein the response comprises a second input signal.

19. The apparatus of claim 1, wherein in response to determining the identification signal matches a record in the identification database, applying a transformational attribute to the input signal during the second computing operation.

20. The apparatus of claim 1, wherein the second input signal is equivalent to the input signal.
